(19) United States
(12) Patent Application Publication
(10) Pub. No.: US 2021/0070283 A1
(43) Pub. Date: Mar. 11, 2021

(54) VEHICLE CONTROL DEVICE

(71) Applicant: Hitachi Automotive Systems, Ltd., Hitachinaka-shi, Ibaraki (JP)

(72) Inventors: Yoshitaka FUKASAWA, Hitachinaka-shi (JP); Masashi SEIMIYA, Hitachinaka-shi (JP); Satoshi MATSUDA, Hitachinaka-shi (JP); Tomoyasu SAKAGUCHI, Hitachinaka-shi (JP); Yusuke KOGURE, Hitachinaka-shi (JP)

(73) Assignee: Hitachi Automotive Systems, Ltd., Hitachinaka-shi, Ibaraki (JP)

(21) Appl. No.: 17/054,231

(22) PCT Filed: May 8, 2019
(86) PCT No.: PCT/JP2019/018330

§ 371 Date: Nov. 10, 2020

(30) Foreign Application Priority Data
Jun. 22, 2018 (JP) 2018-119357

(51) Int. Cl. B60W 30/06; B60W 40/06; G06K 9/00

(52) U.S. Cl. CPC B60W 30/06; B60W 2554/4041; G06K 9/00798; B60W 40/06

(57) ABSTRACT

Provided is a vehicle control device capable of quickly obtaining a route for reaching a target parking position re-recognized during automatic parking control. The vehicle control device includes: a connection route generation unit 33 which generates a target route 47 for moving a vehicle 1 from a parking start position 41 to a target parking position 44a of a target parking frame 44, and generates a connection route 48 for moving the vehicle to the target parking position of the target parking frame re-recognized by a recognition unit 31 while the vehicle moves along the target route from the position of the vehicle; and a mode switching unit which switches from a first mode in which the vehicle 1 moves along the target route 47 to a second mode in which the vehicle 1 moves along the connection route 48, on condition that the connection route 48 is generated.

### TECHNICAL FIELD

The present invention relates to a vehicle control device which is mounted on an automobile to detect an ambient environment of a vehicle and perform parking control.

### BACKGROUND ART

There is an automatic parking system which recognizes a parking frame by an outside world recognition sensor, generates a parking route to the parking frame, controls an accelerator, a brake, a steering, and a shift, and moves an own vehicle to the parking frame.

PTL 1 discloses a technique in which a target travel route for aligning a travel route of an own vehicle with a target line near a front gaze point in front of the vehicle is an arc, and a lateral position deviation is set to zero at a forward gaze point.

### CITATION LIST

### Patent Literature

PTL 1: JP 2016-64799 A

### SUMMARY OF INVENTION

### Technical Problem

As the technique for ensuring the accuracy of the parking position, it is conceivable that the parking space is recognized not only at the start of the automatic parking control but also while the vehicle moves along the parking route by the automatic parking control. For example, as the method for improving parking accuracy by re-recognizing the parking frame when re-approaching the parking space by the automatic parking control, there are a method for regenerating the parking route by restarting the calculation of the parking route from the beginning, and a method for moving the vehicle toward the target parking position by feedback control without using the parking route.

However, the regeneration of the parking route has a high computational load on an ECU, takes time, and is difficult to perform in real time during the automatic parking control. In addition, the method for moving the vehicle by the feedback control, since the control target value changes rapidly according to the movement of the vehicle, the movement of the vehicle becomes unnatural, and there is a risk that the position of the own vehicle will not converge to the target parking position.

The present invention has been made in view of the above-described points, and an object of the present invention is to provide a vehicle control device capable of quickly obtaining a route for reaching a target parking position re-recognized during automatic parking control.

### Solution to Problem

In order to solve the above-described problems, a vehicle control device of the present invention includes: a recognition unit which recognizes a target parking frame; a target route generation unit which generates a target route for moving a vehicle from a parking start position to a target parking position of the target parking frame; a position estimation unit which estimates a position of the vehicle; a connection route generation unit which generates a connection route for moving the vehicle to the target parking position of the target parking frame re-recognized by the recognition unit while the vehicle moves along the target route from the position of the vehicle; and a mode switching unit which switches from a first mode in which the vehicle moves along the target route to a second mode in which the vehicle moves along the connection route, on condition that the connection route is generated.

### Advantageous Effects of Invention

According to the present invention, it is possible to quickly obtain a route for reaching a target parking position re-recognized during automatic parking control.

Further features related to the present invention will become apparent from the description of this specification and the attached drawings. In addition, problems, configurations, and effects other than those described above will be clarified by the following description of the embodiments.

### BRIEF DESCRIPTION OF DRAWINGS

FIG. 1 is a vehicle configuration diagram of a vehicle control device according to an embodiment of the present invention.

FIG. 2 is a functional block diagram of the vehicle control device according to an embodiment of the present invention.

FIG. 3 is an explanatory diagram illustrating an example of the operation of the vehicle control device according to an embodiment of the present invention.

FIG. 4 is a flowchart illustrating the operation of the vehicle control device according to an embodiment of the present invention.

FIG. 5 is an explanatory diagram illustrating an example of the operation of the vehicle control device according to an embodiment of the present invention.

### DESCRIPTION OF EMBODIMENTS

Hereinafter, an embodiment of a vehicle control device according to the present invention will be described in detail with reference to the drawings.

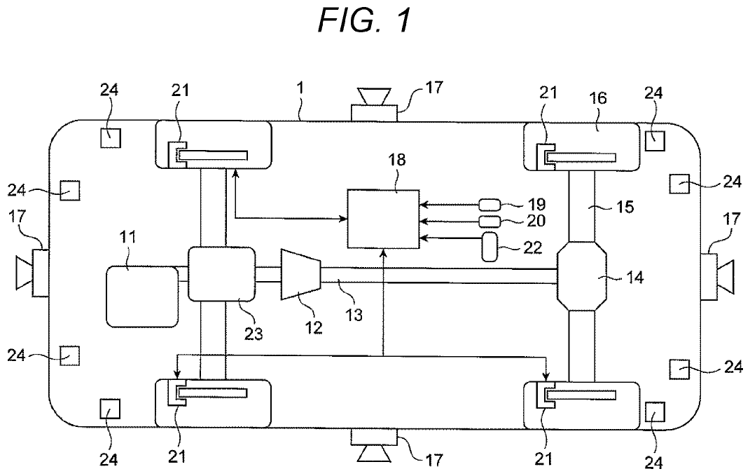

FIG. 1 is a vehicle configuration diagram of a vehicle control device according to an embodiment of the present invention. In the configuration diagram of the vehicle of FIG. 1, the vehicle 1 in the illustrated example is a rear wheel drive vehicle having a general configuration including, for example, an in-cylinder injection type gasoline engine 11 as a drive power source, an automatic transmission 12 that can be connected to and detached from the engine 11, a propeller shaft 13, a differential gear 14, a drive shaft 15, four wheels 16, a hydraulic brake 21 provided with a wheel speed sensor, and an electric power steering 23.

The vehicle 1 is provided with a vehicle control device 18 which controls the devices, actuators, and instruments mounted thereon. The devices, actuators, and instruments, including the vehicle control device 18 and sensors described later, can exchange signals and data through an in-vehicle LAN or CAN communication. The vehicle control device 18 obtains information about the outside of the vehicle 1 from the sensors described later and transmits command values for realizing control such as tracking a leading vehicle or maintaining the center of a white line, preventing lane departure, automatic parking, etc. to the engine 11, the brake 21, the electric power steering 23, and the automatic transmission 12. The wheel speed sensor 21 generates a pulse waveform according to the rotation of the wheels and transmits the pulse waveform to the vehicle control device 18.

A monocular camera 17 and a sonar 24 are provided in the front side, rear side, and lateral side of the vehicle 1. These sensors constitute an outside world recognition sensor which detects the traveling state of obstacles around the vehicle or the road environment and supplies the detection results to the vehicle control device 18. The vehicle control device 18 senses the surroundings of the vehicle using the monocular camera 17 or the sonar 24.

Note that the illustrated vehicle 1 is an example of a vehicle to which the present invention can be applied, and the present invention does not limit the configuration of the applicable vehicle. For example, a vehicle which employs a continuously variable transmission (CVT) instead of the automatic transmission 12 may be used. Furthermore, there may be a vehicle using a motor instead of the engine 11 which is a drive power source, or an engine and a motor as a drive power source.

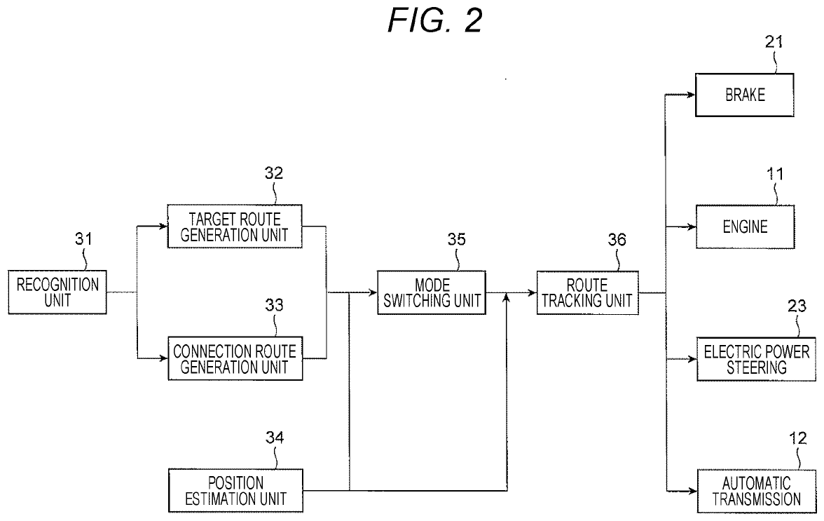

FIG. 2 is a functional block diagram of the vehicle control device according to an embodiment of the present invention.

A recognition unit 31 recognizes a target parking frame based on the detection result of the sensor and transmits a target parking position of the recognized target parking frame to a target route generation unit 32. The recognition unit 31, for example, recognizes the target parking frame from a captured image of the parking frame captured by the monocular camera 17.

The target route generation unit 32 generates a target route for moving the vehicle 1 from a position of the vehicle 1 at the start of parking (parking start position) to a target parking position in the target parking frame. The target parking position is a position which is set in the target parking frame, and in this embodiment, is a position which coincides with a center position of a rear wheel axle of the vehicle when the vehicle is parked in the target parking frame.

A connection route generation unit 33 generates a connection route for moving the vehicle 1 to the target parking position of the target parking frame re-recognized by the recognition unit 31 while the vehicle moves along the target route. The target route generation unit 32 and the connection route generation unit 33 take into consideration constraints such as the minimum turning radius of vehicle 1, and generate the target route and the connection route by combining a linear section, a section for traveling while turning the steering wheel, and a section for stationary steering.

A position estimation unit 34 estimates the position of the own vehicle from a wheel speed pulse output by the wheel speed sensor 21. The position estimation unit 34 can estimate the relative position of the vehicle 1 with respect to the target parking frame recognized by the recognition unit 31.

A mode switching unit 35 performs a process of switching from a first mode in which the vehicle 1 moves along the target route to a second mode in which the vehicle 1 moves along the connection route, on condition that the connection route is generated. When a predetermined condition is satisfied, the mode switching unit 35 switches the target route output by the target route generation unit 32 to the connection route output by the connection route generation unit 33, and outputs it to a route tracking unit 36. The route tracking unit 36 transmits a command value to the brake 21, the engine 11, the electric power steering 23, and the automatic transmission 12 so that the vehicle 1 can track the target route or the connection route. The vehicle control device 18 periodically performs the above-described operations for each control.

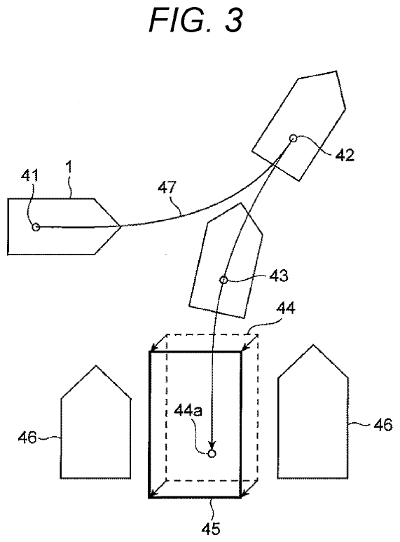

Next, the connection route calculation and mode switching, which are performed by the connection route generation unit 33 and the mode switching unit 35 described above, will be described with reference to FIGS. 3, 4, and 5.

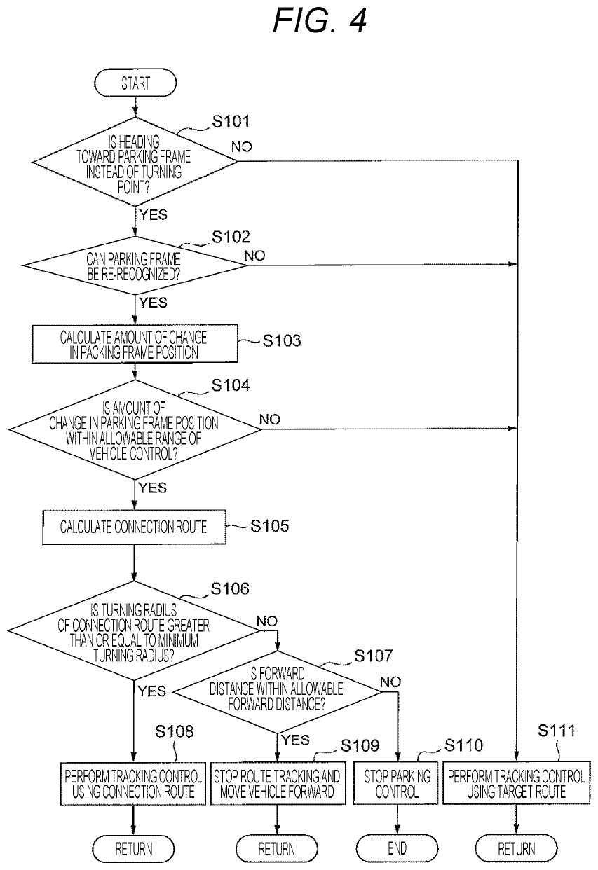

FIG. 3 is an explanatory diagram illustrating an example of the operation of the vehicle control device according to an embodiment of the present invention, and FIG. 4 is a flowchart illustrating the operation of the vehicle control device according to an embodiment of the present invention.

In the example shown in FIG. 3, there is a target parking frame 45 capable of parking the vehicle backward, and other vehicles serving as obstacles 46 are parked in parallel on both sides of the target parking frame 45 in a frame width direction. Due to the automatic parking control, the vehicle moves forward while turning left from a parking start position 41 to a turning point 42, moves backward while turning right from the turning point 42 to the target parking frame 45, and parks at the target parking position of the target parking frame 45. Note that, although FIG. 3 is shown on the assumption that the vehicle is parked backward with respect to the target parking frame 45, the vehicle control device 18 will operate with the same control contents even when the vehicle is parked forward.

A broken-line frame shown in FIG. 3 is the target parking frame 44 recognized when the vehicle is at the parking start position 41, and a solid-line frame shown in FIG. 3 is the target parking frame 45 that is re-recognized while the vehicle moves along the target route 47. A position 43 shown in FIG. 3 is a position at which the recognition unit 31 re-recognizes the target parking frame 45 while the vehicle moves along the target route 47.

First, the recognition unit 31 recognizes the target parking frame 44 at the parking start position 41, and the target route generation unit 32 generates the target route 47 for moving the vehicle from the parking start position 41 to the target parking position 44a of the target parking frame 44.

The route tracking unit 36 controls the movement of the vehicle 1 along the target route 47.

In step S101 of FIG. 4, the mode switching unit 35 determines whether or not the vehicle 1 is heading toward the parking frame instead of the turning point by the vehicle control device 18, that is, whether or not the vehicle is heading toward the target parking frame 44 from the turning point 42 just in front of the target parking frame 44. When it is determined that the vehicle moves from the turning point 42 just in front of the target parking frame 44 toward the target parking frame 44 (YES), the recognition unit 31 performs the process of re-recognizing the target parking frame 44. The recognition unit 31 can recognize the accurate position of the target parking frame by moving the vehicle 1 and approaching the target parking frame 44. Therefore, in this embodiment, the target parking frame 44 is re-recognized when the vehicle 1 moves from the turning point 42 just in front of the target parking frame 44 toward the target parking frame 44.

In step S102, it is confirmed whether or not the target parking frame 45 can be re-recognized as a result of performing the process of re-recognizing the target parking frame 44 by the recognition unit 31. The recognition unit 31 determines that the parking frame has been recognized when the entire target parking frame 45, that is, the front end, the rear end, and the left and right ends of the target parking frame 45 have been all recognized. However, when the left and right ends of the target parking frame 45 can be recognized, it is possible to obtain the lateral displacement of the target parking frame and the yaw-direction displacement. Therefore, when the left and right ends of the target parking frame 45 are recognized, it may be determined that the target parking frame 45 has been recognized.

When it is determined in step S102 that the target parking frame 45 can be re-recognized (YES), the process proceeds to step S103 to calculate the amount of change in the parking frame position. The amount of change in the parking frame position is a lateral displacement (deviation) between the target parking position 44a of the target parking frame 44 recognized by the vehicle 1 at the parking start position 41 and the target parking position 45a of the target parking frame 45 re-recognized in step S102.

When the amount of change in the drive frame position is calculated, the process proceeds to step S104 to determine whether there is a change in the parking frame position, that is, whether or not there is a deviation between the target parking position 44a of the target parking frame 44 recognized when the target route 47 is generated and the target parking position 45a of the target parking frame 45 re-recognized while the vehicle moves along the target route 47 (deviation grasping unit). When there is the deviation, it is determined whether or not the amount of change in the parking frame position is within an allowable range of the vehicle control.

Here, when the amount of change in the parking frame position is larger than the allowable range of the vehicle control (NO in step S104), the lateral displacement cannot be corrected until the vehicle reaches the target parking position 45a, and the vehicle stops with a yaw angle with respect to the target parking frame 45. Therefore, the process proceeds to step S111 to select the first mode and perform the tracking control using the target route 47. In the first mode, the target route 47 generated by the target route generation unit 32 at the start of parking is output from the mode switching unit 35 to the route tracking unit 36, and the route tracking unit 36 controls the vehicle so that the vehicle 1 tracks the target route 47.

Note that, when it is determined in step S101 that the vehicle is not moving from the turning point 42 just in front of the target parking frame 44 toward the target parking frame 44 (NO), or even when it is determined in step S102 that the target parking frame could not be re-recognized by the recognition unit 31 (NO), the process proceeds to step S111 to select the first mode and perform the tracking control using the target route 47.

On the other hand, when there is the change in the parking frame position and the amount of change is within the allowable range of the vehicle control (YES in step S104), the process proceeds to step S105 to calculate the connection route 48.

In step S105, the connection route generation unit 33 performs a process of generating the connection route 48. The connection route 48 is a route in which the position of the vehicle 1 when the recognition unit 31 re-recognizes the target parking frame 45 while the vehicle moves along the target route 47 becomes the route start point 43 and which reaches the target parking position 45a of the target parking frame 45 after re-recognition from the route start point 43. The connection route generation unit 33 generates, as the connection route 48, a simple route including an arc-shaped curved section 48a that is in contact with a straight line connecting the center 45b of the frontage of the target parking frame 45 and the target parking position 45a from the position 43 at which the target parking frame 45 is re-recognized.

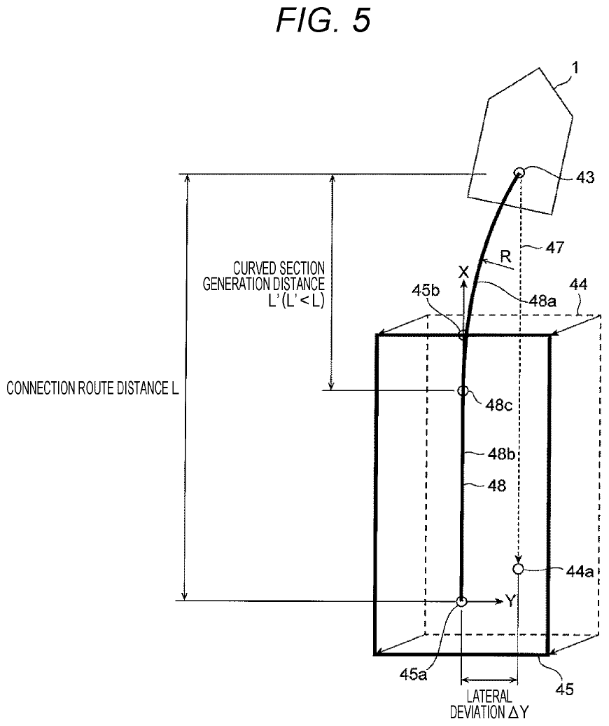

FIG. 5 is an explanatory diagram illustrating an example of the operation of the vehicle control device according to an embodiment of the present invention. In FIG. 5, the description will be given on the assumption that the target parking position 45a of the re-recognized target parking frame 45 is defined as the coordinate origin, the axis in the front-and-rear direction of the frame passing through the center 45b of the frontage of the target parking frame 45 and the target parking position 45a is defined as the X axis, and the axis in the frame width direction that passes through the target parking position 45a and is orthogonal to the X axis is defined as the Y axis.

As shown in FIG. 5, the connection route 48 includes an arc-shaped curved section 48a and a straight-shaped linear section 48b. The linear section 48b is a section set on the straight line (on the X-axis) passing through the center 45b of the frontage of the target parking frame 45 and the target parking position 45a. The curved section 48a has an arc shape that passes through the route start point 43 and is in contact with the straight line (X-axis) connecting the center 45b of the frontage of the target parking frame 45 and the target parking position 45a of the target parking frame 45. A turning radius R of the curved section 48a of the connection route 48 is calculated by the following Equation (1).

$$\begin{matrix}[ Math . 1 ] & \\ R = \frac{{L}^{′ 2}}{2 Δ Y} & Formula ( 1 )\end{matrix}$$

ΔY in the above Equation (1) is the amount of change (lateral deviation) of the parking frame position in the Y-axis direction, and L′ is the length of the curved section 48a of the connection route 48 in the X-axis direction (hereinafter, the curved section generation distance). The curved section 48a and the linear section 48b of the connection route 48 are connected at a connection point 48c so as to be smoothly continuous.

The length of the curved section generation distance L′ is determined by the set position of the connection point 48c. For example, in the case in which the position of the connection point 48c is set to a position that coincides with the center 45b of the frontage of the target parking frame 45, when the vehicle 1 is moved along the connection route 48, the vehicle 1 can be put into the target parking frame 45 without a part of the vehicle 1 protruding from the target parking frame 45 and crossing the lateral frame.

The set position of the connection point 48c may be determined according to the surrounding conditions of the vehicle 1. For example, as shown in FIG. 3, in the case in which there are obstacles 46 such as other vehicles on the left and right of the target parking frame 45, when the vehicle 1 heads for the target parking frame 45, there is a risk of contact with the obstacles 46 if a part of the vehicle 1 protrudes from the target parking frame 45 and crosses the lateral frame. Therefore, it is preferable to set the position of the connection point 48c to the position that coincides with the center 45b of the frontage of the target parking frame 45, so that a part of the vehicle 1 does not protrude from the target parking frame 45.

On the other hand, in the case in which there are no obstacles 46 such as other vehicles on the left and right of the target parking frame 45, there is no problem even if a part of the vehicle 1 protrudes from the target parking frame 45, and the left frame line or the right frame line of the target parking frame 45 may be crossed. Therefore, in the case in which there are no obstacles 46 on the left and right of the target parking frame 45, as shown in FIG. 5, the position can be set between the center 45b of the frontage of the target parking frame 45 and the target parking position 45a. As described above, the position of the connection point 48c may be determined based on whether or not the vehicle 1 is allowed to cross the left frame line or the right frame line of the target parking frame 45 in the connection route 48.

In step S106, it is confirmed whether the magnitude of the turning radius R in the curved section 48a of the connection route 48 is greater than or equal to the minimum turning radius of the vehicle 1. When it is determined in step S106 that the magnitude of the turning radius R is greater than or equal to the minimum turning radius (YES in step S106), the process proceeds to step S108 to switch from the first mode in which the vehicle 1 moves along the target route 47 to the second mode in which the vehicle 1 moves along the connection route 48.

In step S108, the mode switching unit 35 outputs the connection route 48 to the route tracking unit 36, and the route tracking unit 36 performs the tracking control so that the vehicle 1 tracks the connection route 48. That is, the mode switching unit 35 switches from the first mode in which the vehicle 1 moves along the target route 47 to the second mode in which the vehicle 1 moves along the connection route 48. In the second mode, the vehicle 1 moves along the curved section 48a of the connection route 48 and then moves along the linear section 48b.

When it is determined in step S106 that the magnitude of the turning radius R of the curved section 48b of the connection route 48 is less than the minimum turning radius of the vehicle 1 (NO in step S106), it is determined that the vehicle cannot track the connection route 48, and the process proceeds to step S107 and steps subsequent thereto. In step S107 and steps subsequent thereto, a process is performed to determine whether or not the vehicle 1 can be moved in a direction away from the target parking frame 45 to generate a new connection route that can be tracked. Note that, in this embodiment, the case of parking backward is described as an example, and therefore, in the following description, the direction away from the target parking frame 45 is set to forward movement, but is set to backward movement when the vehicle is parked forward.

First, in step S107, it is determined whether or not a forward distance is within a preset allowable forward distance. Here, when it is determined that the forward distance is within the allowable forward distance (YES in step S107), the process proceeds to step S109. In step S109, the route tracking of the connection route 48 is stopped, and the vehicle moves forward from the route start point 43 of the connection route 48.

In step S109, the mode switching unit 35 instructs the route tracking unit 36 to move the vehicle 1 forward, and the connection route is generated after the next control cycle. The vehicle 1 moves forward until the determination in step S106 becomes YES (step S109). In step S109, a process is performed to move the vehicle 1 in a direction away from the target parking frame 45 to generate a new connection route.

That is, in steps S104 to S106, it is determined whether or not the position of the vehicle is a position at which the connection route cannot be generated. In step S109, when the position of the vehicle is a position at which the connection route cannot be generated, the vehicle is moved in a direction away from the target parking frame 45 (moved forward in this embodiment), and the connection route for generating a new connection route is regenerated with the moved position as the route start point.

When the forward distance is greater than the allowable forward distance in step S107 as a result of moving the vehicle forward in step S109 (NO in step S107), it is determined that the regeneration of the connection route is impossible and the generation of the connection route is stopped. Then, the process proceeds to step S110 to stop the parking control.

When the target parking frame 45 is re-generated while the vehicle 1 moves along the target route 47, the vehicle control device 18 of this embodiment includes the connection route generation unit 33 which generates the connection route 48 for moving the vehicle 1 from the re-recognized position 43 to the re-recognized target parking frame 45. The connection route generation unit 33 generates, as the connection route 48, a simple route including an arc-shaped curved section 48a that is in contact with a straight line (X-axis) connecting the center 45b of the frontage of the target parking frame 45 and the target parking position 45a from the position 43 at which the target parking frame 45 is re-recognized. Therefore, the connection route 48, which is the route for reaching the target parking position 45a of the target parking frame 45 re-recognized during the automatic parking control, can be easily and quickly obtained. Therefore, the calculation load of the vehicle control device 18 can be reduced.

Although the embodiments of the present invention have been described in detail above, the present invention is not limited to the above embodiments, and various design changes can be made without departing from the spirit of the present invention described in the claims. For example, the embodiments have been described in detail for easy understanding of the present invention and are not necessarily intended to limit to those including all the above-described configurations. In addition, a part of a configuration of a certain embodiment can be replaced with a configuration of another embodiment, and a configuration of another embodiment can be added to a configuration of a certain embodiment. Furthermore, it is possible to add, remove, or replace another configuration with respect to a part of a configuration of each embodiment.

### REFERENCE SIGNS LIST

31 recognition unit
32 target route generation unit
33 connection route generation unit
34 position estimation unit
35 mode switching unit
36 route tracking unit
41 parking start position
42 turning point
43 route origin of connection route
44 position of target parking frame recognized at start of parking
45 position of target parking frame re-recognized while vehicle moves along target route
46 other vehicles (obstacles)
47 target route
48 connection route
48a curved section
48b linear section

1. A vehicle control device, comprising:
a recognition unit which recognizes a target parking frame;
a target route generation unit which generates a target route for moving a vehicle from a parking start position to a target parking position of the target parking frame;
a position estimation unit which estimates a position of the vehicle;
a connection route generation unit which generates a connection route for moving the vehicle to the target parking position of the target parking frame re-recognized by the recognition unit while the vehicle moves along the target route from the position of the vehicle; and
a mode switching unit which switches from a first mode in which the vehicle moves along the target route to a second mode in which the vehicle moves along the connection route, on condition that the connection route is generated.

2. The vehicle control device according to claim 1, comprising a deviation grasping unit which grasps whether or not there is a deviation between the target parking position of the target parking frame recognized when the target route is generated and the target parking position of the target parking frame re-recognized while the vehicle moves along the target route,
wherein the connection route generation unit generates the connection route when the deviation grasping unit determines that there is the deviation.

3. The vehicle control device according to claim 2, wherein the connection route includes a linear section on a straight line passing through a center of a frontage of the target parking frame and the target parking position, and a curved section which is in contact with the linear section.

4. The vehicle control device according to claim 3, wherein
a position at which the recognition unit re-recognizes the target parking frame while the vehicle moves along the target route is set as a route start point of the connection route, and
in the second mode, the vehicle moves along the curved section and then moves along the linear section.

5. The vehicle control device according to claim 4, wherein a position at which the linear section and the curved section are in contact with each other is the center of the frontage of the target parking frame.

6. The vehicle control device according to claim 4, wherein a position at which the linear section and the curved section are in contact with each other is a position between the center of the frontage of the target parking frame and the target parking position of the target parking frame.

7. The vehicle control device according to claim 4, wherein a position at which the linear section and the curved section are in contact with each other is determined based on whether or not the vehicle is allowed to cross a left frame line or a right frame line of the target parking frame in the connection route.

8. The vehicle control device according to claim 1, wherein the connection route generation unit determines whether or not the position of the vehicle is a position at which the connection route cannot be generated, and when the position of the vehicle is a position at which the connection route cannot be generated, the connection route generation unit regenerates the connection route by moving the vehicle in a direction away from the target parking frame.

9. The vehicle control device according to claim 8, wherein, when it is determined that the connection route cannot be regenerated, the connection route generation unit stops generating the connection route.

10. The vehicle control device according to claim 1, wherein the connection route generator generates the connection route based on the target parking position of the target parking frame re-recognized by the recognition unit while the vehicle moves from a turning point just in front of the target parking position to the target parking position.

11. The vehicle control device according to claim 1, wherein the connection route generation unit generates the connection route when the entire target parking frame is re-recognized by the recognition unit.

12. The vehicle control device according to claim 1, wherein the connection route generation unit generates the connection route when left and right ends of the target parking frame are recognized by the recognition unit.

13. The vehicle control device according to claim 4, wherein the curved section of the connection route has an arc shape.

14. The vehicle control device according to claim 1, wherein the vehicle is parked forward in the target parking frame.

15. The vehicle control device according to claim 1, wherein the vehicle is parked backward in the target parking frame.

16. The vehicle control device according to claim 1, wherein the connection route generation unit generates, as the connection route, a route including an arc-shaped curved section that is in contact with a straight line connecting a center of a frontage of the target parking frame and the target parking position from a position at which the target parking frame is re-recognized.

17. The vehicle control device according to claim 16, wherein a turning radius of the curved section of the connection route is calculated by the following Equation (1):
$$\begin{matrix}[ Math . 1 ] & \\ R = \frac{{L}^{′ 2}}{2 Δ Y} & Formula ( 1 )\end{matrix}$$
(where ΔY is a deviation between the target parking position of the target route and the target parking position of the connection route, and L′ is a length of the curved section of the connection route).
